(19) United States
(12) Patent Application Publication
(10) Pub. No.: US 2006/0178756 A1
(43) Pub. Date: Aug. 10, 2006

(54) Terminal appliance and management method therefor

(76) Inventors: Jinichiro Gotoh, Hitachi (JP); Kenji Araki, Mito (JP); Toshihiro Morikawa, Naka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/315,215

(22) Filed: Dec. 23, 2005

(30) Foreign Application Priority Data
Dec. 27, 2004 (JP) 2004-375243

(51) Int. Cl. G05B 15/02; G05B 19/18

(52) U.S. Cl. 700/9; 700/65; 700/66

(57) ABSTRACT

A terminal appliance having a sensor for detecting information on a work target appliance with physical quantities, a first electronic tag which records the information on the work target appliance, a read/write unit for reading/writing the information in the first electronic tag, and information in a second electronic tag which records the personal information on the user, and an arithmetic-logic processing unit for making the work target appliance usable only when the information on the work target appliance and the read personal information on the user coincide with information stored in the first electronic tag and the second electronic tag in advance, the information on the work target appliance being identified based on the physical quantities detected by the sensor.

### BACKGROUND OF THE INVENTION

The present invention relates to a novel terminal appliance (apparatus) and a management method therefor for permitting mobile terminal appliances (apparatuses), measurement appliances, and vehicles to be normally operated only in a certain position and environment, and for preventing the appliances from being stolen. Here, the mobile terminal appliances, measurement appliances, and vehicles are the ones used in places such as prevention and maintenance work site or construction site of a power-generation plant, and manufacturing and assembly site of its various kinds of machines.

In the management method for the mobile appliances such as mobile telephones and mobile-type computers, a method has been employed which makes a judgment as to whether or not the user is truly an authentic user by asking the user to input his or her authentication code at the time of power-on and software start-up. In recent years, a scheme has been employed which performs the authentication by using an individual-owned card or electronic medium.

In the computers, in the case of a security-function-equipped computer in particular, there exists a method which prohibits an access to the computer if the computer's security device is removed without authorization. Here, an electronic tag is used for a judgment system which executes a program at the time of power-on of the computer. At this time, the electronic tag allows the judgment system to make the judgment as to whether or not the security device is removed in the unauthorized manner. This method has been disclosed in JP-A-2001-43142.

As a method for preventing an outsider from entering a room without permission, or from taking an appliance out of the room without permission, there exists a system which attaches electronic tags on personnel and components concerned. These electronic tags allow management of entrance/exit of the personnel and articles into/out-of a facility, and management of bring-in or take-out of the articles. In a facility where no key-equipped door is set up, this method makes it possible to monitor whether or not an outsider enters a room without permission, or takes an appliance out of the room without permission. This monitoring allows the system to immediately issue a warning if it is required. This method has been disclosed in JP-A-2004-21310.

As a method whose object is to prevent a vehicle from being stolen, there exists a system which carries out a communications processing on a regular basis between both appliances of an on-vehicle appliance and an out-vehicle appliance. If a problem has occurred, this system detects a communications abnormality resulting therefrom, then issuing a steal warning to the vehicle's owner and an emergency report center. This method has been disclosed in JP-A-2004-161121.

Meanwhile, as a method for allowing an appliance itself to judge a certain environment thereby to determine its own operation contents, a driving support system exists. In this system, the vehicle itself measures the driving situation from its various kinds of sensors. Moreover, the vehicle itself judges driver's skill and ability, thereby giving a driving support. This method has been disclosed in JP-A-2004-171060 and JP-A-2003-118425.

### SUMMARY OF THE INVENTION

In construction work site or maintenance work site of a plant, a large number of personnel visit or leave the work site. In addition thereto, a large number of appliances such as measurement appliances, management appliances, and information appliances are brought into the work site for accomplishments of various works. Many of these work target appliances used in the work site are expensive ones, and thus are in a danger of being stolen. Moreover, in some cases, a work target appliance which must not be used because how to use it is complicated happens to be used by being mistaken. Even an accident takes place which is caused by the fact that a mistake has been made on how to use the work target appliance. Conventionally, in order to deal with these problems, a gate has been set up, thereby carrying out a baggage check or the like at the time of gate entrance/exit. However, it can not necessarily be said that sufficient check has been carried out. This is because there exists the problem of privacy, and because there exist the large number of work target appliances which turn out to become the targets.

Meanwhile, in the case of, e.g., automobiles, various kinds of steal prevention appliances have been already used. Many of these steal prevention appliances, however, are retrofitted to an automobile after the manufacturing thereof. This has made it impossible to deal with the case where the steal prevention appliances are going to be removed. Also, although an example of a key-based electronic authentication exists, a component concerned with this electronic authentication is only a control unit for the engine. As a result, if this component has been removed, it becomes difficult to deal with the case where the configuration components are stolen.

In dealing with these problems, in the case of the scheme which performs authentications by individual-owned cards or electronic media for the use authentications of the work target appliances, if these individual-owned cards or electronic media have been stolen together with the work target appliances, there exists a possibility that the work target appliances become available. Also, if, for the authentication at program level, a single work target appliance is stolen and is disassembled into pieces on each component basis, there exists a high possibility that the individual components become available. Moreover, once the authentications have been performed, the work target appliances are basically usable no matter what position or environment the work target appliances are placed in.

In the case of the security-function-equipped computer, there exists a necessity for the authentication by the electronic tag built in the work target appliance. If the computer's security device is removed without authorization, the access to the computer will be prohibited. Accordingly, the danger of being stolen is reduced as compared with the case where the authentication by the card or electronic medium is performed. The object of this method, however, is to prevent the unauthorized access to the device. Consequently, if the entire device has been stolen, the device is disassembled into components. As a result, there will occur a possibility of the secondary utilization. Furthermore, once the authentication has been performed, the appliance is basically usable no matter what position or environment the appliance is placed in.

There exists the system which attaches the electronic tags on personnel and components concerned. These electronic tags allow the management of entrance/exit of the personnel and articles into/out-of a facility, and the management of bring-in or take-out of the articles. This method is preconditioned on the gate entrance/exit into/out-of a facility which is completely isolated. As a result, this method is difficult to use in the case of an open space or if the gate management is difficult. Accordingly, the management based thereon is difficult to accomplish if there exists a possibility that, like an automobile, a work target appliance itself dealt with as the target displaces over a wide area, or if the use range is a wide one.

There exists the system which carries out a communications processing on a regular basis between both work target appliances of an on-vehicle work target appliance and an out-vehicle work target appliance. If a problem has occurred, this system detects a communications abnormality resulting therefrom, then issuing a steal warning to the vehicle's owner and the emergency report center. In this method, however, there exists the following possibility if the vehicle's owner is not located near the vehicle, or if the emergency report center is located at a considerable distance: Namely, a delay may occur between the point-in-time when the problem occurred and the system issued the steal warning and the point-in-time when the emergency report center took some countermeasure after receiving the steal warning. Also, since the communications processing is carried out on a regular basis between both of the work target appliances, electric power which accompanies the communications becomes necessary. Consequently, if a device for detecting the communications abnormality is removed for some reason or other, there exists a possibility that individual components are disassembled from the work target appliances.

In view of these systems and methods, the method is effective which allows a work target appliance itself to judge an environment where the appliance is placed, and to control its own operation state. In any one of the conventional technologies in the prior art documents, however, automobiles are mainly selected as the targets. Namely, their object is to support the driving in correspondence with skill and ability of the driver of an automobile. These technologies measure the position from the GPS information, then measuring the driving environment such as acceleration, road situation, and rainfall situation. Also, these technologies judge the driver's skill and ability on the basis of information registered in advance and the environment information where the automobile is moving. The object of these technologies, however, is the utilization by the automobile. As a result, the measurements concerned therewith are, in most cases, the ones of physical quantity state associated with the movement of the work target appliance. Accordingly, it is difficult to apply these technologies to a static work target appliance or the like.

Also, in the authentication of the driver, in many cases, the card or password is used. Moreover, once the authentication has been performed, the automobile is usable even in the case of an unauthorized driver. Furthermore, in this case, the driver is assumed to drive a specific automobile. Accordingly, if the driver has driven any other automobile, the driving history or skill and ability of the driver in person will not be updated at whatever time.

It is an object of the present invention to provide a terminal appliance and a management method therefor which, based on information on a work target appliance and personal information on the user, make the work target appliance available only to a user who has been registered in advance. In addition thereto, the terminal appliance and the management method therefor permit the work target appliance to be normally operated only in a certain position and environment, and prevent the work target appliance from being stolen.

In the present invention, there is provided a terminal appliance including a sensor, a first electronic tag (hereinafter, referred to as “IC tag”), and an electronic-tag read/write unit. In this terminal appliance, various types of physical quantities are measured from the sensor, and the place where a work target appliance is placed is identified from position information and environment information where the work target appliance is placed. Moreover, information on the user is read from an identification card equipped with a second electronic tag. Here, the terminal appliance is usable only in the case of an environment and a user registered in the second electronic tag in advance. If the place where the work target appliance is placed and the user thereof are not the one registered in advance, the terminal appliance will lose its function.

Namely, there is provided the terminal appliance including the sensor and the electronic tags. The use place and user of a work target appliance are registered in the first electronic tag. Via the work-target-appliance read/write unit, the information on the user is read from the identification card equipped with the second electronic tag. Moreover, the various types of physical quantities are measured from the sensor, thereby identifying the position and environment where the work target appliance is placed. As a result, the work target appliance is made operable in the case of only the place and user registered in advance. Namely, the work target appliance is made usable in the case of only the determined person and determined place and environment.

As the position information and environment information where a work target appliance is placed, at least one of measurement results of the physical quantities measured from the sensor is used. Examples of such physical quantities are as follows: Temperature, humidity, GPS position information, altitude, pressure, air constituent, vibration, light, electromagnetic field, horizontal degree, and sound.

After identifying the position and environment where the work target appliance is placed, it is possible to change the use range and operation contents of the work target appliance depending on the skill and ability of the user. If the use environment is changed, or if the skill and ability of the user is lower as compared with the one determined in advance, a warning device provided in the work target appliance issues a warning. Furthermore, the work target appliance is made unusable, and is caused to lose its function.

There exists the following method: Namely, of the information for identifying the position and environment where the work target appliance is placed, by using at least either of the GPS position information and the vibration, it is judged that the position where the work target appliance is placed is a position on the sea. In this method, if, as a result of measuring the vibration by an accelerometer, a vibration within a constant period range continues for a constant time-interval, the work target appliance is made unusable after that, and is caused to lose its function.

If the work target appliance is transported without authorization using a ship or an airplane, by detecting not only the GPS information but also the vibration information, it is judged that the work target appliance is being transported in the unauthorized manner.

Moreover, there exists the following method: Namely, of the information for identifying the position and environment where the work target appliance is placed, by using the light information, the position where the work target appliance is placed is judged. In this method, a structure is employed where, if a time during which the light quantity is smaller than a certain constant value continues for a constant time-interval, the function of the work target appliance after that is caused to be lost. In addition, there exists the following method: Namely, of the information for identifying the position and environment where the work target appliance is placed, by using the sound information, the steal is judged. In this method, despite the situation that power of the work target appliance is not switched on, if a time during which the sound pressure is at a certain sound-pressure level continues for a constant time-interval, the function of the work target appliance after that is caused to be lost.

If the work target appliance is transported in an unauthorized manner by being packed into a container or the like, by detecting the situation that the work target appliance has been in a no-light state for a long time, it is judged that the work target appliance is being transported without authorization.

If the work target appliance is transported without authorization by being mounted on a truck or the like, by detecting a stationary noise generated at the time of the transportation, it is judged that the work target appliance is being transported in the unauthorized manner.

Furthermore, the following structure is employed: Namely, an authentication system is installed in the work target appliance so that the work target appliance will be operated in the case of only a specific user who has been registered in advance. The authentication is configured by at least one of or a combination of more than two of biometrics, personal identification number, pass word, and identification card. These pieces of authentication information are written into the first electronic tag.

In addition, the read/write unit is provided in a place where the work target appliance is to be used. Only when a person registered in advance as the user of the work target appliance has performed a use authentication of the work target appliance in a place registered in advance as the place where the work target appliance is to be used, the work target appliance is made usable. Moreover, the use achievement of the work target appliance is written into the electronic tag of the work target appliance and that of the user.

According to the present invention, it becomes possible to provide a terminal appliance and a management method therefor which, based on information on a work target appliance and personal information on the user, make the work target appliance available only to a user who has been registered in advance. In addition thereto, the terminal appliance and the management method therefor permit the work target appliance to be normally operated only in a certain position and environment, and prevent the work target appliance from being stolen.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram of the mobile terminal appliance according to the present invention;

FIG. 2 is a flow diagram for illustrating operation processing steps of the mobile terminal appliance according to the present invention at the time of normal use after the power-on;

FIG. 3 is a flow diagram for illustrating outline of registration processing steps of basic information;

FIG. 4 is a diagram for illustrating an example of authentication method, use, and characteristic of a worker;

FIG. 5 is a diagram for illustrating an example of physical quantity measured, sensor used, and judgment condition which are to be used for position judgment;

FIGS. 6A and 6B are diagrams for illustrating an example where the position judgment is made based on detection of vibration;

FIG. 7 is a perspective view for illustrating the configuration of a work target appliance and a terminal appliance in a closed work place;

FIG. 8 is a configuration diagram for illustrating the configuration of a plurality of work target appliances and a terminal appliance;

FIG. 9 is a configuration diagram of another embodiment of the mobile terminal appliance according to the present invention;

FIG. 10 is a cross-sectional view of an IC package equipped with an electronic tag;

FIG. 11 is a configuration diagram where the mobile terminal appliance according to the present invention is applied to an automobile; and

FIG. 12 is a diagram for illustrating a set example of the usable range.

### DESCRIPTION OF THE EMBODIMENTS

Hereinafter, based on concrete embodiments, the explanation will be given below concerning the modes for carrying out the present invention.

### Embodiment 1

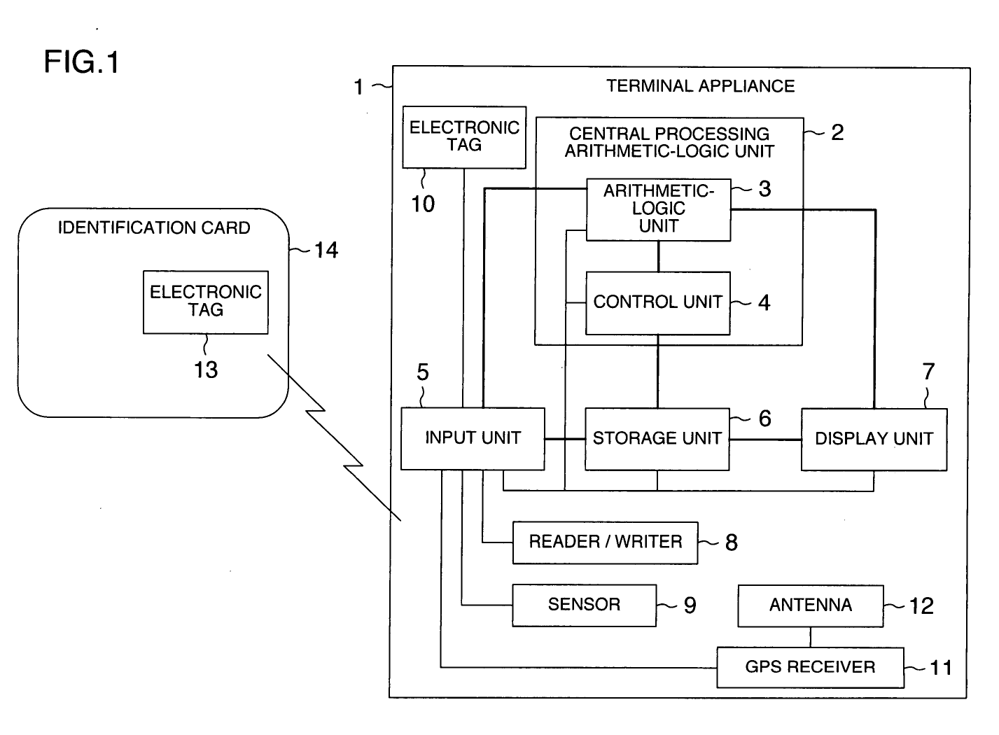

FIG. 1 is a configuration diagram of the terminal appliance according to the present invention. In the present embodiment, a terminal appliance 1 is provided in a work target appliance. The terminal appliance 1 includes a central processing arithmetic-logic unit 2, an arithmetic-logic unit 3, a control unit 4, an input unit 5, a storage unit 6, and a display unit 7. Also, the terminal appliance 1 includes therein a reader/writer 8 which becomes a read/write unit, a sensor 9, a first electronic tag 10, a GPS receiver 11, and an antenna 12. The first electronic tag 10 has in advance stored the following information therein: Places and environments where the terminal appliance 1 is usable, or places to which there exists a possibility of the terminal appliance 1's being transported, e.g., factories, regions, and countries, affiliations, classifications, names, and levels of workers to whom the terminal appliance 1 is usable, and the like. The terminal appliance 1 may be used either as a mobile terminal appliance or in the manner of being provided in the work target appliance.

The sensor 9 measures physical quantities for identifying the place where the terminal appliance 1 exists. Also, the terminal appliance 1 includes the GPS receiver 11 and the antenna 12 for identifying the place where the terminal appliance 1 exists. The terminal appliance 1 is configured as follows: Namely, based on a method which will be described later, the terminal appliance 1 detects from moment to moment the place where the terminal appliance 1 exists or is used at present at the time of use start and during the use. Then, unless the places detected are the ones for which the use of the terminal appliance 1 had been registered in advance, the terminal appliance 1 is made unusable after that. Even in the middle of halting the use, the terminal appliance 1 detects on a regular basis the place where the terminal appliance 1 exists at present. Then, unless the places detected are the ones for which the use or transportation of the terminal appliance 1 had been registered in advance, the terminal appliance 1 is made unusable after that.

Meanwhile, a worker who is going to use the terminal appliance 1 owns an identification card 14 in which a second electronic tag 13 is built. The second electronic tag 13 built in the identification card 14 has in advance stored therein personal information on the worker. Examples of the personal information are affiliation, name, and work of the worker, information as to whether or not the terminal appliance 1 is usable to the worker, and so on. When making use of the terminal appliance 1, the worker who owns the identification card 14 brings his or her own identification card 14 closer to the terminal appliance 1, thereby carrying out the use authentication. Wireless communications allows implementation of the information exchange between the identification card 14 and the terminal appliance 1. The reader/writer 8 of the terminal appliance 1 reads the personal information on the worker from the second electronic tag 13, then making a comparison check as to whether or not the worker is a one who had been registered in the storage unit 6 in advance. Only in the case of the authentic worker, the operating system of the terminal appliance 1 will be started up. This results in a state where it is possible to use the terminal appliance 1 in an authorized manner.

On the other hand, in the case of a worker who had not been registered in the storage unit 6, the operating system of the terminal appliance 1 will not be started up. This makes it impossible to use the terminal appliance 1. Once the terminal appliance 1 has been made unusable, it becomes required for the authentic (authorized) worker to carry out the use authentication once again. Use start time-and-date and use termination time-and-date of the terminal appliance 1 by the worker is written into the second electronic tag 13 built in the identification card 14 of the worker. Meanwhile, the use start time-and-date and use termination time-and-date of the terminal appliance 1 by the worker is written into the storage unit 6 in the terminal appliance 1. Even in the case of the authentic worker, the terminal appliance 1 is made unusable unless the identified place where the terminal appliance 1 exists is one of the places and environments where the terminal appliance 1 is usable, or the places to which there exists a possibility of the terminal appliance 1's being transported, e.g., the factories, regions, and countries registered in the first electronic tag 10 in advance.

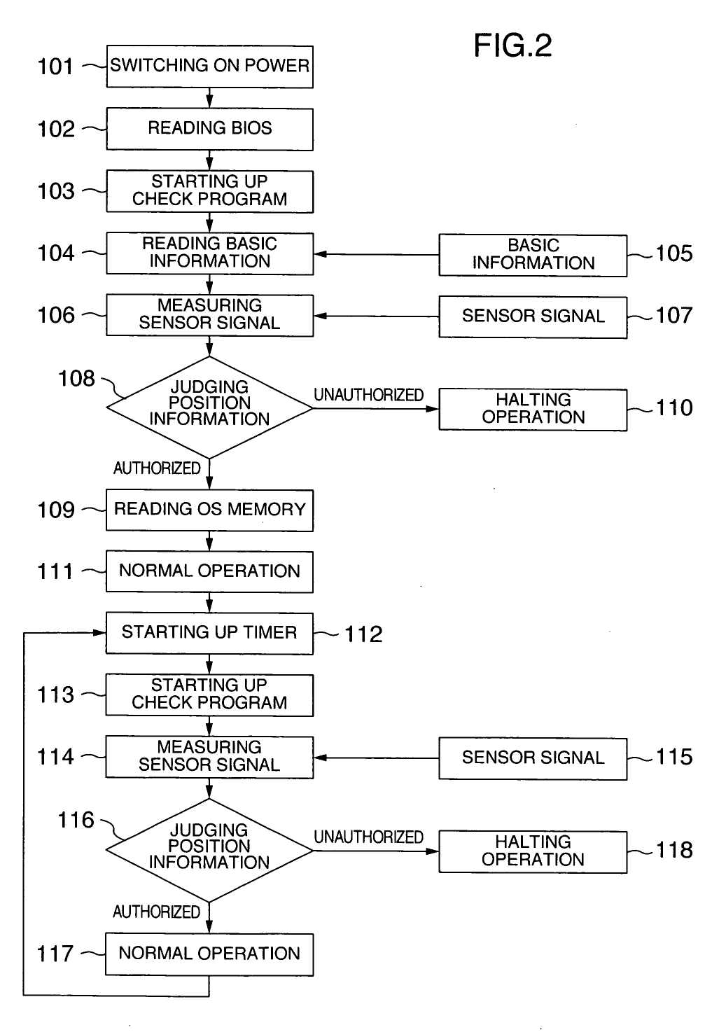

FIG. 2 is a flow diagram for illustrating operation processing steps of the terminal appliance according to the present invention at the time of normal use after the power-on. At a step 101, the power is switched on. Then, at a step 102, a BIOS reading is carried out. At a step 103, a check program is started up. Moreover, at a step 104, reading basic information 105 is performed. What is referred to as “basic information” here are as follows: The places and environments where the terminal appliance 1 is usable, or the places to which there exists a possibility of the terminal appliance 1's being transported, e.g., the factories, regions, and countries, and further, the affiliations, classifications, names, and levels of workers to whom the terminal appliance 1 is usable.

In a sensor-signal measurement at a step 106 next thereto, a sensor signal 107 is measured. A comparison is made between the basic information 105 read at the step 104 and the sensor signal 107 measured at the step 106, thereby, at a step 108, making a judgment on position information where the terminal appliance exists. If, from the position information, the place where the terminal appliance 1 exists at present has been judged to be an authorized place, the terminal appliance proceeds to an OS-memory reading at a step 109. Meanwhile, if, from the position information, the place where the terminal appliance 1 exists at present has been judged to be an unauthorized place, the terminal appliance transfers to an operation halting at a step 110. After the OS-memory reading at the step 109, the terminal appliance 1 transfers to a normal operation at a step 111. After that, during the normal operation, a timer is being started up as indicated by a step 112. This timer plays a role of a trigger, thereby causing a check program at a step 113 to be started up.

Interval of this trigger by the timer is recorded into the basic information 105 in advance. A sensor-signal measurement at a step 114 after the check program start-up at the step 113, a sensor signal at a step 115, a position-information judgment at a step 116, and an operation halting at a step 118 correspond to the above-described steps 106, 107, 108, and 110, respectively. If, from the position information, the place where the terminal appliance 1 exists at present has been judged to be an authorized place, the terminal appliance 1 transfers to a normal operation at a step 117. After that, the terminal appliance returns to the timer start-up at the step 112, then repeating the operations ranging from the check program start-up at the step 113 to the normal operation at the step 117. In this way, in the present invention, the terminal appliance 1 itself checks and determines the place where the terminal appliance 1 exists at present on a regular basis not only at the start-up time when the use of the terminal appliance 1 had been started, but also during the use of the terminal appliance 1. This allows implantation of a structure which enhances security of the terminal appliance 1, and which beforehand prevents the terminal appliance from being stolen. The occurrence interval of the trigger by the timer at the step 112, i.e., operation of the check program, can be set as being, at the shortest, the processing-rate interval by the central processing arithmetic-logic unit 2.

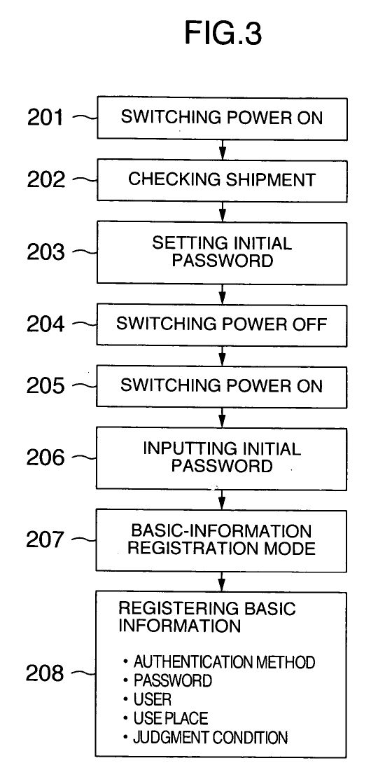

FIG. 3 is a flow diagram for illustrating outline of registration processing steps of the basic information. At first, after the final assembly of the product has been completed, at the time of shipment and inspection, the power is switched ON at a step 201. After that, at a step 202, a shipment check is carried out. At a step 203 which is the final step at that time, an initial password is set. After that, at a step 204, the power is switched OFF. Next, at a step 205, the power is switched ON once again. Then, an initial-password input is performed at a step 206. At a step 207, the processing enters a basic-information registration mode. After that, at a step 208, registering the basic information is performed. Usually, the steps 205 to 208 are carried out by a user who has purchased the appliance. If, however, the basic registration information had been known at the time of product shipment, the registration may be performed before the shipment. The basic information to be registered at the step 208 are information such as authentication method, password, user, use place, and judgment condition. As the judgment condition, the user himself or herself can set each parameter, or may utilize initial values prepared in advance as a model pattern.

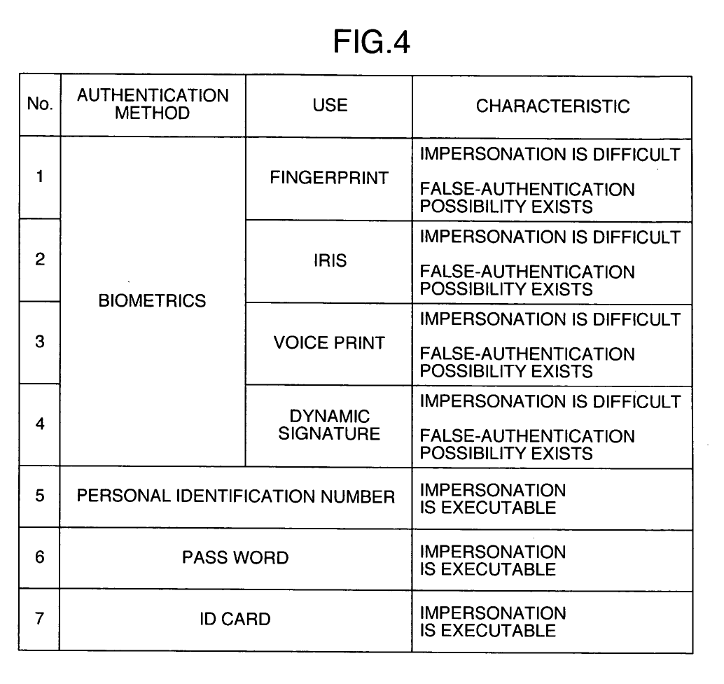

FIG. 4 is a diagram for illustrating an example of the authentication method, use, and characteristic of a worker. Examples of the authentication method are biometrics, personal identification number, pass word, identification card, and the like. Of these methods, the biometrics includes methods such as fingerprint, iris, voice print, and dynamic signature. The respective authentication methods exhibit their own characteristics, and these methods can be used in a manner of being combined with each other.

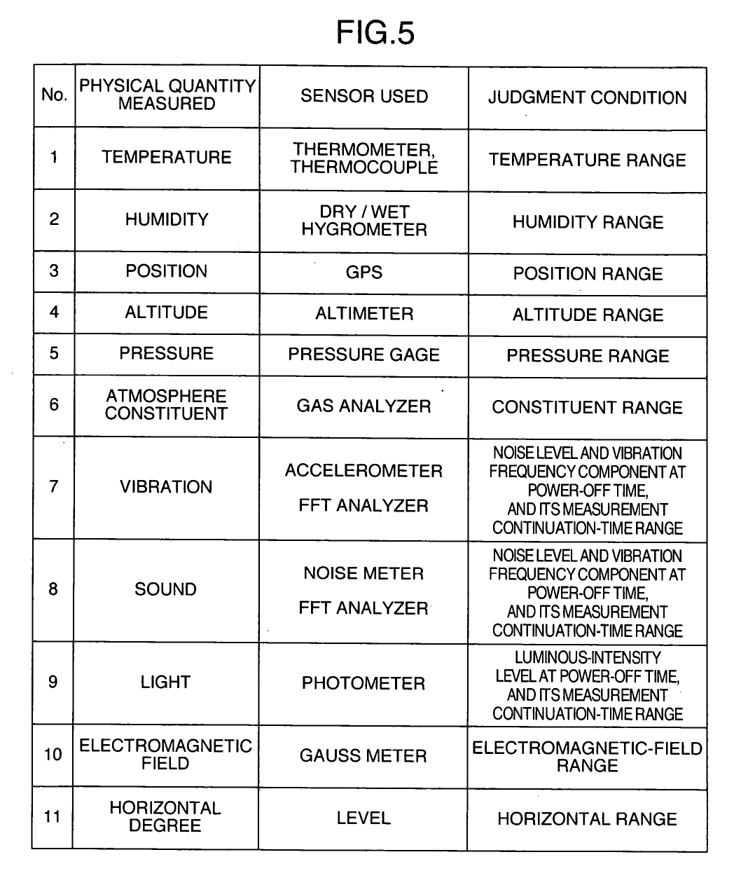

FIG. 5 is a diagram for illustrating an example of physical quantity measured, sensor used, and the judgment condition which are to be used for the position judgment on the terminal appliance. Examples of the physical quantity measured are as follows: Temperature, humidity, position, altitude, pressure, atmosphere constituent, vibration, sound, light, electromagnetic field, horizontal degree, and the like. Sensors used for measuring the respective physical quantities are as follows: Thermometer or thermocouple for the temperature, dry/wet hygrometer for the humidity, GPS (: Global Positioning System) for the position, altimeter for the altitude, pressure gage for the pressure, gas analyzer for the atmosphere constituent, accelerometer and FFT (: Fast Fourier Transform) analyzer for the vibration, noise meter and FFT analyzer for the sound, photometer for the light, Gauss meter for the electromagnetic field, and level for the horizontal degree. The judgment condition differs depending on each physical-quantity basis. The judgment is made from factors such as instantaneous value, average value during a certain time-interval, maximum value, minimum value, change ratio, and variation pattern.

For example, the GPS allows implementation of an accurate position judgment on the terminal appliance. If, however, the radio waves do not reach the appliance, there exists a possibility that whatever judgment cannot be made. In that case, detecting, e.g., a swing by sea waves makes it possible to judge that the appliance exists on the sea at present. Moreover, if the appliance has been in storage for a long time with the power switched OFF in a place where none of the light reach the appliance completely, it is judged that the appliance has been stolen. Furthermore, if a vibration with one and the same pattern continues over several hours with the power switched OFF, it is judged that the appliance is in a situation of having been stolen and being transported.

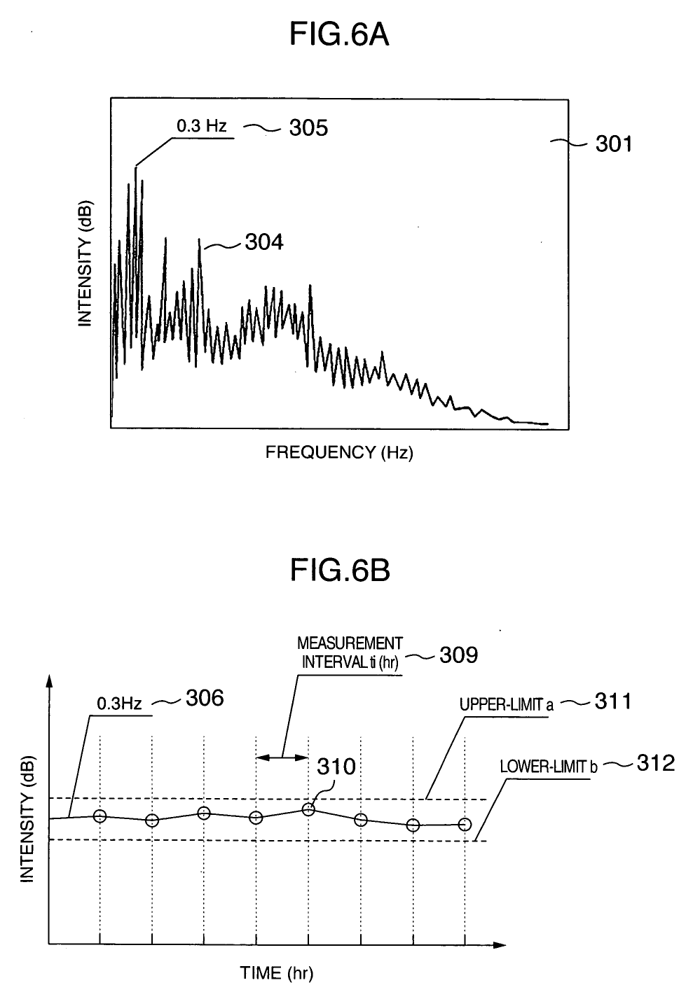

FIGS. 6A and 6B are diagrams for illustrating an example where the position judgment on the terminal appliance is made based on the detection of a vibration. FIG. 6A illustrates an example of power spectrum resulting from applying the FFT processing to signal of a vibration measured by an accelerometer. The transverse axis denotes frequency components of the vibration, and the longitudinal axis denotes intensities (dB) of the respective frequency components. FIG. 6A shows that the highly-projecting vibration frequency components are main components of the vibration. In FIG. 6A, the vibration frequency component 305 at 0.3 Hz projects most steeply of all, and the vibration frequency components at the right and left thereof project in steepness which is the next to the 0.3-Hz vibration frequency component 305.

FIG. 6B is a diagram for illustrating a time change in intensity of the measurement value at 0.3 Hz. The transverse axis denotes measurement time, and the longitudinal axis denotes the intensity of the measurement value. In FIG. 6B, the value is measured for each measurement interval ti 309. The measurement value 310 of the 0.3-Hz vibration frequency component 306 falls within the range of the lower-limit value 312 to the upper-limit value 311.

Determine a condition that, if the 0.3-Hz vibration has fallen between the lower-limit value b 312 to the upper-limit value a 311 within an in-measurement-time range, the terminal appliance will exist on the sea. Then, register this condition as the basic information. At this time, based on the vibration analysis using the accelerometer and the FFT analyzer, the judgment that the appliance exists on the sea is performed. Of course, in the case of an actual sea surface, there appear vibration components due to a lot of sea waves. Accordingly, it is advisable that the condition to be set as the basic information be such as an appropriately determined relationship among the frequencies, intensities, and continuation times, or a combination of several conditions.

As having been explained so far, according to the present embodiment, it becomes possible to provide the terminal appliance and the management method therefor which are usable only in a specific position and environment, and which are made usable in the case of only a worker determined in advance. In addition thereto, the terminal appliance and the management method therefor manage use history of a work target appliance and the user, thereby permitting the work target appliance to be normally operated only in a determined position and environment. This allows the terminal appliance and the management method therefor to manage the work target appliance and the work thereby, and to prevent the work target appliance from being stolen.

Also, the terminal appliance and the management method therefor make it possible to manage the mobile terminal appliances, measurement appliances, vehicles, and the works thereby. Also, the terminal appliance and the management method therefor make it possible to prevent steals of the work target appliances, work target appliances mounted on the vehicles, and the vehicles. Here, the mobile terminal appliances, measurement appliances, and vehicles are the ones used in the places such as prevention and maintenance work site or construction site of a power-generation-plant, and manufacturing and assembly site of its various kinds of machines.

### Embodiment 2

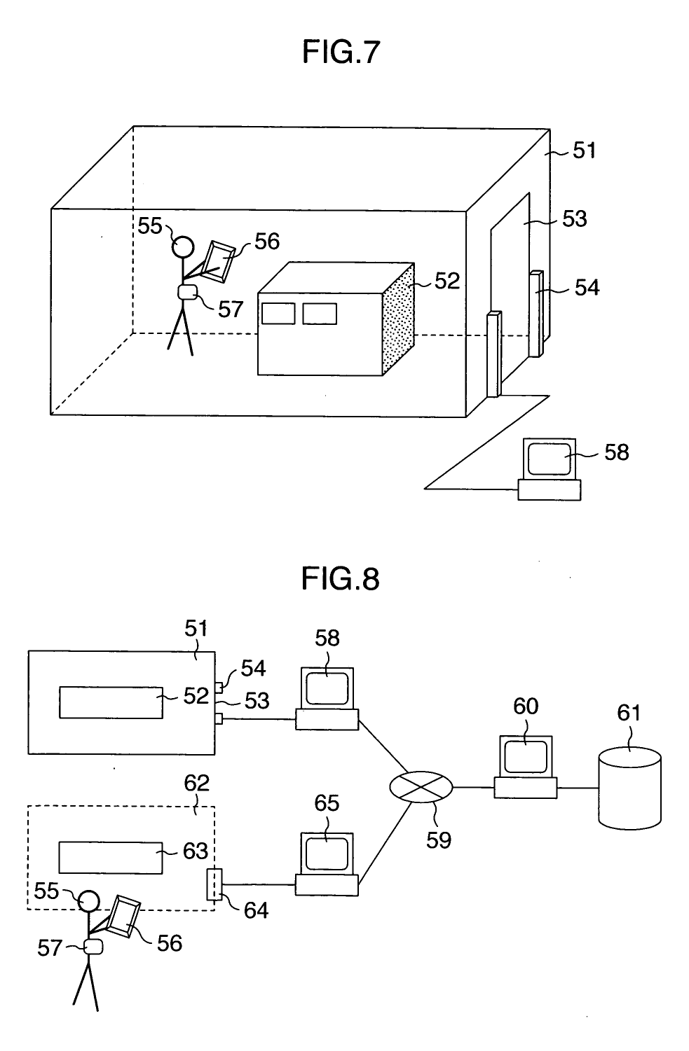

FIG. 7 is a perspective view for illustrating the configuration of the mobile terminal appliance according to the present invention and a work target appliance in a closed work place. In the present embodiment, a mobile terminal appliance 56 itself has the configuration illustrated in FIG. 1. Being closed means that the entrance/exit into/out-of the place where a work is to be carried out is not free from the outside, and that the work place and places other than that are separated from each other by a single gate or entrance/exit or a plurality of gates or entrances/exits. A work target appliance 52 exists within the work place 51. The work place 51 has an entrance/exit 53, at which there exists a gate 54 equipped with an electronic-tag read/write unit. A worker 55 owns the mobile terminal appliance 56 and a worker identification card 57. When entering the work place 51, the worker 55 performs an entrance authentication by using the worker identification card 57. Only when the entrance has been authenticated, an entrance/exit and appliance-use management unit 58 manages the entire appliance which allows the entrance into the work place 51.

If the entrance has been not authenticated, the entrance/exit 53 will be automatically locked, or a report will be issued to the manager of the work place 51. If the mobile terminal appliance 56 is the steal-prevention-unit-equipped appliance illustrated in FIG. 1, only the worker 55 who has been authenticated at the gate 54 finds it possible to use the mobile terminal appliance 56. Namely, the mobile terminal appliance 56 becomes available only in the work place 51. As a result, the work target appliance 52 is made usable only therein.

FIG. 8 is a configuration diagram for illustrating the relationship of the mobile terminal appliance with a plurality of work target appliances. FIG. 8 illustrates the entire configuration of a closed work place 51 as illustrated in FIG. 7 and an unclosed work area 62. Unlike the closed work place 51, the work area 62 is located in an unclosed space. The work place 51 and the work area 62 are near to each other in some cases, and are at a distance in the other cases. Moreover, there are some cases where there exist a plurality of work places 51 and work areas 62. A post 64 equipped with an electronic-tag read/write unit exist in the vicinity of the work area 62. A gate 54 and the post 64 equipped with the electronic-tag read/write unit are respectively connected to entrance/exit and appliance-use management units 58 and 65 for managing the whole of work target appliances 52 and 63. Furthermore, the entrance/exit and appliance-use management units 58 and 65 are connected to a higher-order management unit 60 and a database 61 via a network 59.

When using a mobile terminal appliance 56 in the vicinity of the work target appliance 63, a worker 55 performs an entrance authentication by applying his or her worker identification card 57 to the post 64 equipped with the electronic-tag read/write unit. Then, information indicating the fact that the work authentication has been performed is written into the worker identification card 57. This allows the mobile terminal appliance 56 to fall into an available state, thereby making the work target appliance 63 usable. In this case, however, the work area 62 is not separated from the outside. As a result, there exists a possibility that the worker 55 will take out the mobile terminal appliance 56 to the outside of the work area 62 to use the appliance 56.

A first method for preventing this possibility is as follows: Namely, available time for the mobile terminal appliance 56 is limited to about four hours at the maximum. Then, when this limited time has expired, the mobile terminal appliance 56 is made unusable unless the work authentication is performed once again. A second method therefor is as follows: Namely, an automatic authentication is carried out with a constant time-interval placed, using the post 64 equipped with the electronic-tag read/write unit, the worker identification card 57, and the mobile terminal appliance 56. Then, after a lapse of a certain constant time, this automatic authentication will cease to be performed. As a result, the mobile terminal appliance 56 becomes unusable. A method obtained by combining both of the first method and the second one is conceivable.

In the present embodiment as well, as is the case with the first embodiment, it becomes possible to provide the terminal appliance and the management method therefor which are usable only in a specific position and environment, and which are made usable in the case of only a worker determined in advance. In addition thereto, the appliance and the method therefor manage use history of a work target appliance and the user, thereby permitting the work target appliance to be normally operated only in a determined position and environment. This allows the appliance and the method therefor to manage the work target appliance and the work thereby, to prevent the work target appliance from being stolen, and to be applied to various kinds of appliances.

### Embodiment 3

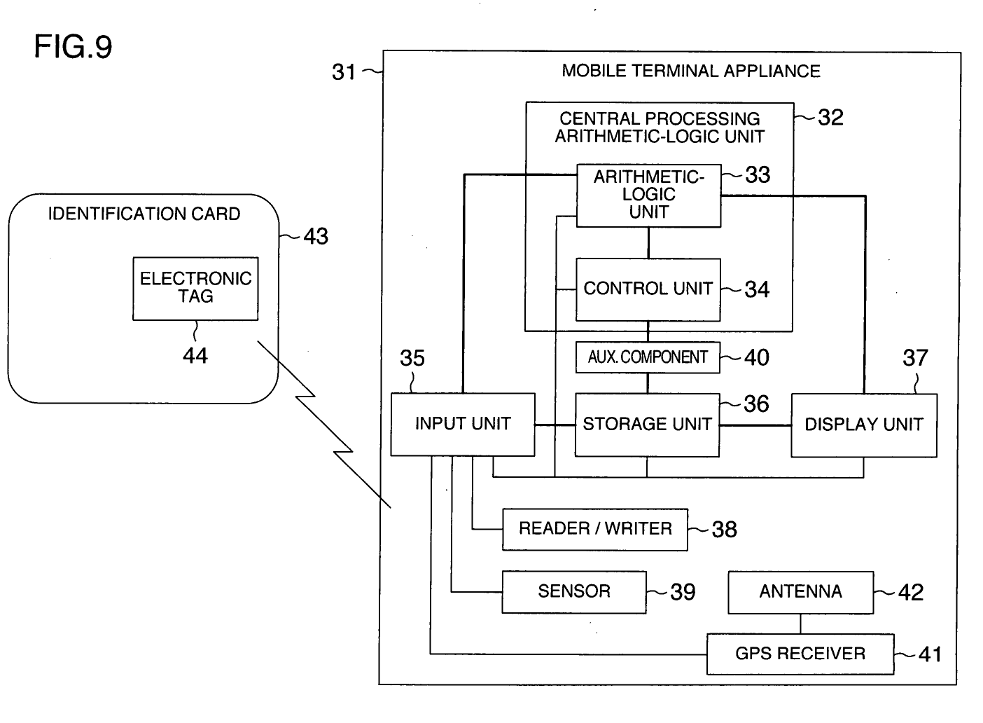

FIG. 9 is a configuration diagram of another embodiment of the terminal appliance according to the present invention. In the present embodiment, in substitution for the first electronic tag 10 in the first embodiment, an electronic-tag-equipped auxiliary component 40 is provided between a control unit 34 and a storage unit 36 which are included inside a terminal appliance 31. From the point-of-view of steal prevention, the electronic-tag-equipped auxiliary component 40 is provided so that the component 40 will also serve as a connection among the respective components inside the terminal appliance 31. The larger the number of the electronic-tag-equipped auxiliary components 40 becomes, the more influential the effect of the steal prevention becomes. Consequently, if the electronic-tag-equipped auxiliary component 40 has been removed, the terminal appliance 31 is made unusable. This allows the terminal appliance to manage a work target appliance and the work thereby, and to prevent the work target appliance from being stolen.

### Embodiment 4

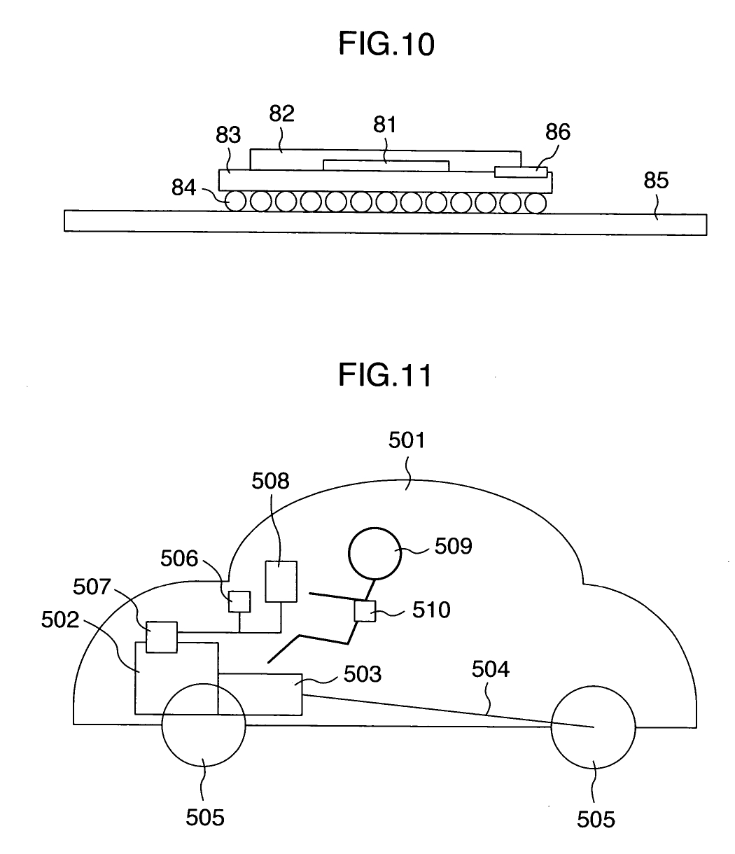

FIG. 10 is a cross-sectional view of an IC package equipped with an electronic tag. An IC chip 81 is fixed on a substrate 83 by a sealing resin 82. The substrate 83 is fixed on a substrate 85 by solder balls 84. Here, an electronic tag 86 is fixed by being sandwiched between the sealing resin 82 and the substrate 83. In this case, if the electronic tag 86 is removed forcefully, the sealing resin 82 and the substrate 83 flake off, and thus the IC package becomes inoperable. Characteristic information on the IC package is written into the electronic tag 86, and is used for the management and authentication of the components. The IC package in the present embodiment corresponds to the central processing arithmetic-logic unit 2 illustrated in FIG. 1. Information on work target appliances is recorded into the electronic tag 86.

### Embodiment 5

FIG. 11 is a configuration diagram where the terminal appliance according to the present invention is applied to an automobile. An automobile 501 is driven in such a mechanism that power acquired by a power unit 502 is transmitted to wheels 505 through the use of a speed-variable unit 503 and a power transmission unit 504. Control over the power unit 502 is performed by a power control unit 507. The automobile 501 includes a driver identification unit 506 and an automobile-used information terminal appliance 508 equipped with a first-electronic-tag read/write unit. The automobile-used information terminal appliance 508, which is connected to the power control unit 507, performs an operation authentication of the power control unit 507. Namely, the automobile 501 will not be activated without the authentication by the automobile-used information terminal appliance 508.

In order to identify the place where the automobile 501 exists, as is the case with FIG. 1, the automobile-used information terminal appliance 508 similarly includes the GPS receiver, the antenna, the sensor, and the other configuration components. The automobile-used information terminal appliance 508 is structured as follows: Namely, as is the case with the terminal appliance 1 illustrated in FIG. 1, the terminal appliance 508 detects from moment to moment the place where the terminal appliance exists or is used at present at the time of use start and during the use. Then, unless the places detected are the ones for which the use of the terminal appliance had been registered in advance, the operation authentication will not be performed by the power control unit 507 after that. Also, even in the middle of halting the use of the automobile 501, the terminal appliance detects on a regular basis the place where the automobile 501 exists. Then, unless the places detected are the ones for which the use or transportation of the automobile 501 had been registered in advance, the operation authentication will not be performed by the power control unit 507 after that.

Also, a driver 509 owns an identification card 510 equipped with a second electronic tag which records the personal information therein. When the driver 509, who owns the identification card 510 with the driver, rides on the automobile 501, and is going to start to use the automobile 501, the driver identification unit 506 reads the information in the identification card 510, then making a comparison check between the information and contents registered in advance. As a result of the comparison check, if the information in the identification card 510 is authentic information, the driver identification unit 506 issues a signal to the power control unit 507. Then, a signal issued from the power control unit 507 makes the automobile 501 usable. The identification card 510 has in advance registered therein times-and-dates and places where the automobile 501 is usable. If the information in the identification card 510 is not the authorized data, the driver identification unit 506 is controlled not to issue the signal to the power control unit 507. This restricts the driver 509, thereby making it possible to prevent the automobile 501 from being stolen. In that case, a different and separate unit is used for reading/writing the information in the identification card 510.

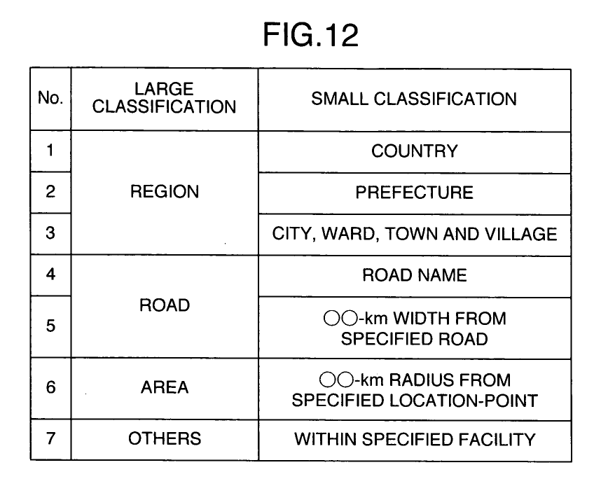

FIG. 12 is a diagram for illustrating a set example of the usable range in which the automobile 501 is usable. The user selects an arbitrary place out of the large classification and small classification. As the large classification items, there exists, e.g., region. As the small classification items included in the region, there exist items such as country, prefecture, and city, ward, town and village. Also, as the large classification items, there exists, e.g., road. As the small classification items included in the road, there exist items such as road name and setting like “oo-Km width from a specified road”. Also, as the large classification items, there exists, e.g., area from a specified location-point. Here, the automobile-used information terminal appliance 508 is structured as follows: Namely, when the place where the automobile-used information terminal appliance 508 exists exceeds out of this set range, the automobile-used information terminal appliance 508 is caused to lose its function. This allows the user and use place to be restricted, thereby making it possible to prevent the appliance and the automobile from being stolen.

In the present embodiment as well, as is the case with the foregoing embodiment, it becomes possible to permit a work target appliance to be normally operated only in a determined position and environment. Moreover, it becomes possible to manage the work target appliance and the work thereby, to prevent the work target appliance from being stolen, and to manage various kinds of appliances and vehicles and prevent them from being stolen.

It should be further understood by those skilled in the art that although the foregoing description has been made on embodiments of the invention, the invention is not limited thereto and various changes and modifications may be made without departing from the spirit of the invention and the scope of the appended claims.

1. A terminal appliance, comprising:
a sensor for detecting information on a work target appliance with physical quantities,
a first electronic tag which records therein said information on said work target appliance,
a read/write unit for reading/writing said information in said first electronic tag, and information in a second electronic tag which records therein personal information on a user, and
an arithmetic-logic unit for making said work target appliance usable only when said information on said work target appliance and said read personal information on said user coincide with information stored in said first electronic tag and said second electronic tag in advance, said information on said work target appliance being identified based on said physical quantities detected by said sensor.

2. The terminal appliance according to claim 1, wherein said information on said work target appliance is about a position and its environment, said work target appliance being placed at said position.

3. The terminal appliance according to claim 1, wherein said sensor includes a device for detecting at least one of said physical quantities, said physical quantities being temperature, humidity, GPS position information, altitude, pressure, air constituent, vibration, light, electromagnetic field, horizontal degree, and sound.

4. The terminal appliance according to claim 1, wherein said personal information is one of or a combination of more than two of a biometrics, a personal identification number, a pass word, and an identification card.

5. The terminal appliance according to claim 1, wherein said read/write unit writes use achievement of said work target appliance into said first electronic tag and said second electronic tag of said user.

6. The terminal appliance according to claim 1, wherein said arithmetic-logic unit has an arithmetic-logic processing for making said work target appliance unusable if said information on said work target appliance and said information on said user do not coincide with said information stored in advance.

7. The terminal appliance according to claim 1, wherein said arithmetic-logic unit is capable of changing use range and operation contents of said work target appliance depending on skill and ability of said user,
said arithmetic-logic unit having an arithmetic-logic processing for issuing a warning or an arithmetic-logic processing for making said work target appliance unusable, if use environment is changed or if said skill and ability of said user is lower as compared with skill and ability set in advance.

8. The terminal appliance according to claim 1, wherein said arithmetic-logic unit has an arithmetic-logic processing,
said arithmetic-logic processing
judging whether or not a position exists on the sea based on at least either of position information and vibration detected by said sensor, said work target appliance being placed at said position, and, if said vibration continues within a constant period range for a constant time-interval,
making said work target appliance unusable after said continuation of said vibration.

9. The terminal appliance according to claim 1, wherein said arithmetic-logic unit has an arithmetic-logic processing,
said arithmetic-logic processing, if a time during which light quantity of light is smaller than a certain constant quantity continues for a constant time-interval, said light being detected by said sensor,
making said work target appliance unusable after said continuation of said time.

10. The terminal appliance according to claim 1, wherein said arithmetic-logic unit has an arithmetic-logic processing,
said arithmetic-logic processing, if, when power of said work target appliance is not switched on, sound-pressure level of a sound continues at a level higher than a predetermined level for a constant time-interval, said sound being detected by said sensor,
making said work target appliance unusable after said continuation of said sound-pressure level.

11. A method of managing a terminal appliance,
said terminal appliance including a sensor for detecting information on a work target appliance with physical quantities, a first electronic tag which records therein said information on said work target appliance, and a read/write unit for reading/writing said information in said first electronic tag, and information in a second electronic tag which records therein personal information on a user,
said method, comprising the steps of:
measuring said various kinds of physical quantities by using said sensor,
identifying said information on said work target appliance based on said measurement results,
reading said personal information on said user from said personal information, and
making said work target appliance usable only when said identified information on said work target appliance and said read personal information on said user coincide with information on said work target appliance and personal information on said user registered in advance.

12. The method according to claim 11, wherein said physical quantities are temperature, humidity, GPS position information, altitude, pressure, air constituent, vibration, light, electromagnetic field, horizontal degree, and sound.

13. The method according to claim 11, wherein said personal information is one of or a combination of more than two of a biometrics, a personal identification number, a pass word, and an identification card.

14. The method according to claim 11, further comprising a step of writing use achievement of said work target appliance into said first electronic tag and said second electronic tag of said user.

15. The method according to claim 11, further comprising a step of making said work target appliance unusable if said information on said work target appliance and said information on said user do not coincide with said information stored in advance.

16. The method according to claim 11, wherein use range and operation contents of said work target appliance are capable of being changed depending on skill and ability of said user,
said method further comprising a step of issuing a warning or making said work target appliance unusable, if use environment is changed or if said skill and ability of said user is lower as compared with skill and ability set in advance.

17. The method according to claim 11, wherein said physical quantities are at least either of GPS position information and vibration,
said method further comprising the steps of: if said vibration detected continues within a constant period range for a constant time-interval,
judging that a position exists on the sea, said work target appliance being placed at said position, and
making said work target appliance unusable after said continuation of said vibration.

18. The method according to claim 11, wherein said physical quantity is light,
said method further comprising a step of, if a time during which light quantity of said light is smaller than a certain constant quantity continues for a constant time-interval,
making said work target appliance unusable after said continuation of said time.

19. The method according to claim 11, wherein said physical quantity is information on sound,
said method further comprising a step of, if, when power of said work target appliance is not switched on, a time during which said sound is at a certain sound-pressure level continues for a constant time-interval,
making said work target appliance unusable after said continuation of said time.
